(19) United States
(12) Patent Application Publication
(10) Pub. No.: US 2006/0229062 A1
(43) Pub. Date: Oct. 12, 2006

(54) Protection method using a password verifying schedule for a mobile communication device

(75) Inventors: Cheng-Shing Lai, Taipei (TW); Baggio Zhang, Nanking (CN)

Correspondence Address: BACON & THOMAS, PLLC, 625 SLATERS LANE, FOURTH FLOOR, ALEXANDRIA, VA, 22314, US

(73) Assignee: Inventec Appliances Corp., Taipei (TW)

(21) Appl. No.: 11/395,315

(22) Filed: Apr. 3, 2006

(30) Foreign Application Priority Data
Apr. 6, 2005 (TW) 094110930

(51) Int. Cl. H04M 1/66

(52) U.S. Cl. 455/411

(57) ABSTRACT

A protection method using a password verifying schedule for a mobile communication device is disclosed in this invention, which comprises at least the steps of setting a password verifying schedule and a first password then storing said password verifying schedule and said first password, determining whether system time of the mobile communication device equals set time in said password verifying schedule, and acquiring a second password from a user if the system time equals the set time then verifying whether said second password matches said first password or the mobile communication device working normally if said second password matches said first password, or restricting functions of the mobile communication device if said second password doesn't match said first password and working normally if the system time does not equal the set time.

### FIELD OF THE INVENTION

The present invention relates to a protection method using a password verifying schedule for a mobile communication device, and more particularly to a method allowing users to use a password verifying schedule in a mobile communication device to periodically check if the password input by the user is correct to enhance the security of said mobile communication device.

### BACKGROUND OF THE INVENTION

Mobile communication devices, such as cell phones, have essentially become portable communication products in daily life. Conventional prior protection is the method of password-setting in the phone or the SIM ( Subscriber Identity Module) card such that if a cell phone is lost or stolen, others are not allowed to make unauthorized phone calls. Such protection method implementing a booting password protects the phone, but it has some drawbacks. For example, although a password is required to be input in order to boot the phone, as long as it's not shut off, the password verification will not take place, and therefore all functions of the phone are remained fully available.

### SUMMARY OF THE INVENTION

To overcome the drawbacks associated with said prior method, a protection method using a password verifying schedule for a mobile communication device according to the present invention has been developed so that a user can be authenticated periodically by setting up a password verifying schedule for improving the security of the phone.

To achieve above-mentioned purpose, a protection method using a password verifying schedule for a mobile communication device according to the present invention comprises at least the following steps of setting a password verifying schedule and a first password, then storing said password verifying schedule and said first password, periodically determining whether system time of the mobile communication device equals set time in said password verifying schedule, acquiring a second password from a user if the system time equals the set time and then verifying whether said second password matches said first password, the mobile communication device working normally if said second password matches said first password or restricting functions of the mobile communication device if said second password doesn't match said first password, and working normally if the system time does not equal the set time.

As stated above, because the protection method using a password verifying schedule for a mobile communication device according to the present invention provides a way to setup a periodical password verifying schedule, it avoids inconvenience of inputting the password in order to boot the phone, and in the mean time it also enhances the security of the phone since it verifies the password periodically.

The above and other objects, features and advantages of the present invention will become apparent from the following detailed description taken with the accompanying drawings.

### BRIEF DESCRIPTION OF THE DRAWINGS

FIG. 1 is block diagram of a preferred embodiment for a mobile communication device which is protected by using a password verifying schedule according to the present invention.

FIG. 2 shows a flow chart of setting a password verifying schedule in a mobile communication device which is protected by using a password verifying schedule according to the present invention.

FIG. 3 shows a flow chart of executing a password verifying schedule in a mobile communication device which is protected by using the password verifying schedule according to the present invention.

FIG. 4 shows a flow chart of verifying a password in a mobile communication device which is protected by using the password verifying schedule according to the present invention.

### DETAILED DESCRIPTION OF THE PREFERRED EMBODIMENTS

A detailed description of a preferred embodiment of a protection method using a password verifying schedule for a mobile communication device according to the present invention will be provided with reference to the figures, wherein the same device will be referred to with the same mark and number across the figures.

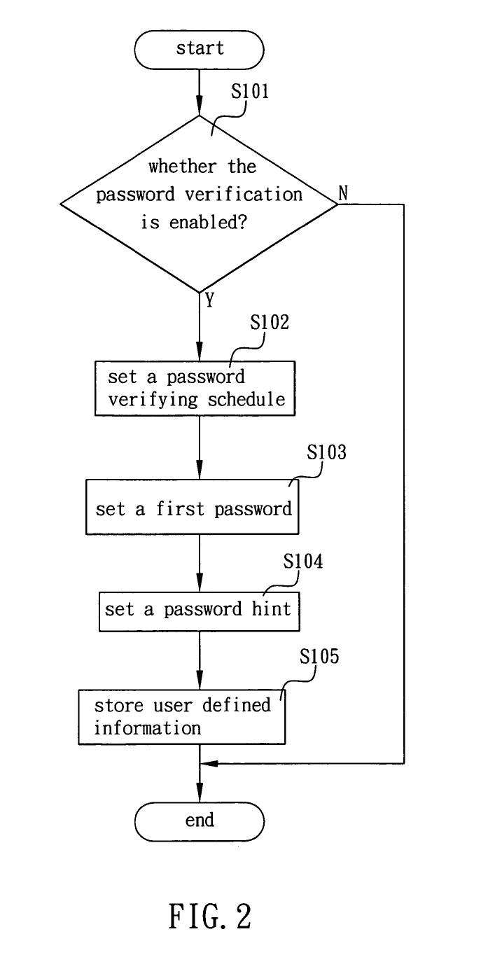

As depicted in FIG. 2. a preferred embodiment of a protection method using a password verifying schedule for a mobile communication device according to the present invention includes the following steps.

(S101) determining whether password verification is enabled;

(S102) setting a password verifying schedule;

(S103) setting a first password;

(S104) setting a password hint; and

(S105) storing the password verifying schedule, said first password and said password hint.

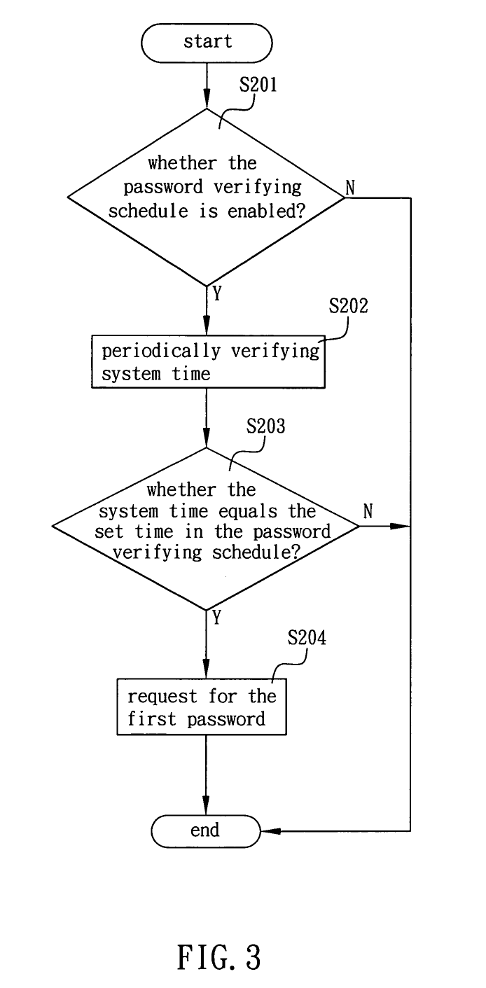

As depicted in FIG. 3. the preferred embodiment further includes the following steps.

(S201) determining whether said password verifying schedule is enabled, if it is enabled, going to the step (S202) and if it is not enabled said mobile communication device working normally;

(S202) verifying system time of the mobile communication device periodically;

(S203) determining whether the system time equals the set time in the password verifying schedule, if yes, going to the step (S204) and if no, said mobile communication device working normally;

(S204) requesting for the first password, and said mobile communication device working normally.

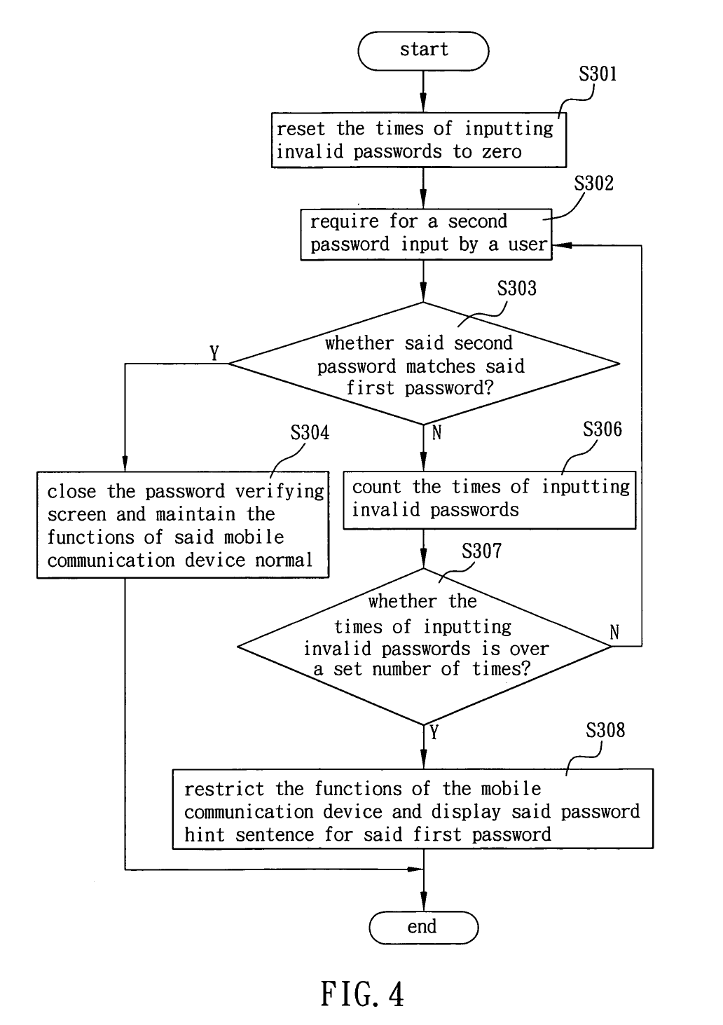

As depicted in FIG. 4. if a password verifying is required, then the preferred embodiment further includes the following steps.

(S301) resetting the times of inputting invalid passwords to zero;

(S302) requiring for a second password input by a user;

(S303) determining whether said second password matches said first password, if yes, going to the step (S304), and if no going to the step (S306);

(S304) closing the password verifying screen and maintaining the functions of said mobile communication device normal;

(S306) counting the times of inputting invalid passwords;

(S307) determining whether the times of inputting invalid passwords is over a set number of times (e.g. three times), if yes, going to the step (S308), and if no, going back to the step (S302);

(S308) restricting the functions of the mobile communication device and displaying said password hint sentence for said first password such as “Please call 12345678 for Mr. Wang!” or “school”.

In the above, said password verifying schedule can be a period of time which starts upon storing the said password verifying schedule and said first password or upon verification that said second password matches said first password. The set time in said password verifying schedule can be periodically occurring at an interval of a day, a week or a month.

Wherein the functions of said mobile communication device can be restricted for the user within only answering phone calls or receiving short messages, so that when said mobile communication device is lost, the original owner may use the phone call or text messages to contact with the person who picks up said mobile communication device. The functions of said mobile communication device can be restricted for the user only within making an emergency phone calls, disabling the operation of the mobile communication device, or causing the mobile communication device to enter into a shut down procedure, so that a lost or stolen mobile communication device won't be able to make unauthorized phone calls.

The following is another preferred embodiment of a protection method using a password verifying schedule for a mobile communication device. To make it easily understandable, the same reference marks and numbers for the same devices used in the previous embodiment are implemented.

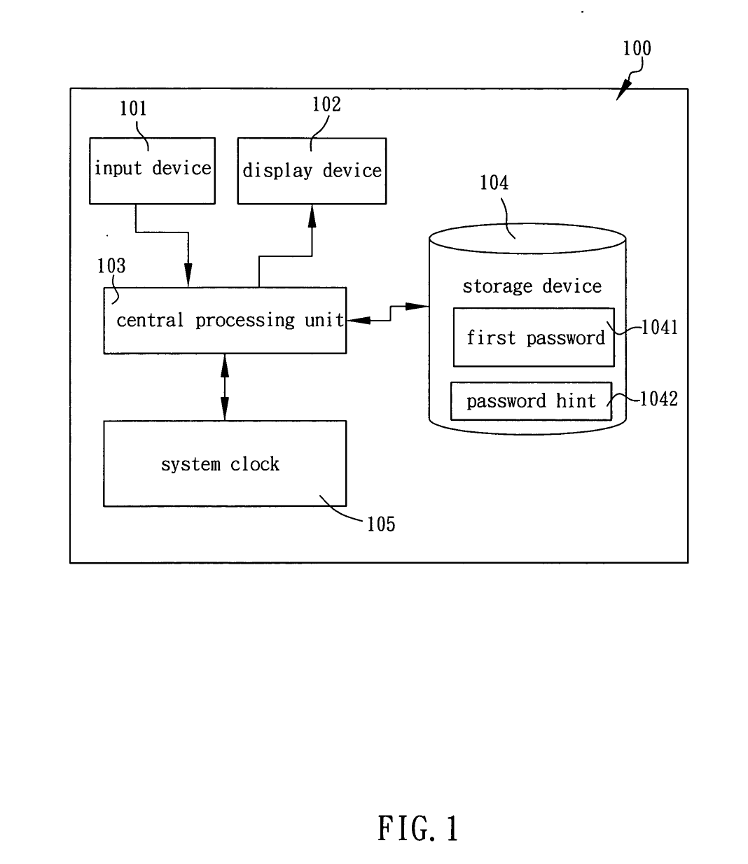

As depicted in FIG. 1, a mobile communication device 100 which is protected by using a password verifying schedule comprises a input device 101 for inputting information by a user, a display device 102 for displaying the information, a central processing unit 103 for processing the information, a storage device 104 for storing the information and a system clock 105 for providing a system time.

After said input device 101 receives a command of enabling said password verifying schedule, a first password 1041 and a password hint 1042 from a user, said central processing unit 103 stores said first password 1041 and password hint 1042 into said storage device 104. When said central processing unit 103 detects that a password verifying schedule is enabled, it then acquires a system time from a system clock 105 and periodically determines whether the system time equals the set time in the password verifying schedule. When the system time equals the set time, said central processing unit 103 displays a message via said display device 102 requesting the user to input a second password, otherwise remains the functions of said mobile communication device 100 normal. After a second password input via said input device 101 by said user, said central processing unit 103 then determines whether said second password matches said first password. The mobile communication device 100 works normally if said second password matches said first password 1041, or the central processing unit 103 restricts the functions of the mobile communication device 100 if said second password doesn't match said first password 1041. Otherwise, the mobile communication device 100 works normally if the system time does not equal the set time.

Said password verifying schedule can be a period of time which starts at the time when said first password is stored in said storage device 104 by said central processing unit 103 or when a valid password is input by a user. Said password verifying schedule can be periodically occurring at an interval of a day, a week or a month.

If said password input is determined to be invalid by said central processing unit 103, said central processing unit 103 starts to count the times of inputting invalid passwords, restricts the functions of said mobile communication device when said times of inputting invalid passwords is over a set number of times, (e.g. three or five times), and said central processing unit 103 then displays a password hint 1042 on said display device 102 to prompt said first password.

The functions of said mobile communication device 100 can be restricted within only making an emergency phone calls, disabling the operation of the mobile communication device, or causing the mobile communication device to enter into a shut down procedure, so that a lost or stolen mobile communication device won't be able to make unauthorized phone calls.

While the invention herein disclosed has been described by means of specific embodiments, numerous modifications and variations could be made thereto by those skilled in the art without departing from the scope and spirit of the invention set forth in the claims.

What is claimed is:

1. A protection method using a password verifying schedule for a mobile communication device, comprising the following steps:
setting a password verifying schedule and a first password for the mobile communication device;
storing said password verifying schedule and said first password;
periodically determining whether system time of the mobile communication device equals set time in said password verifying schedule;
acquiring a second password from a user if the system time equals the set time, then verifying whether said second password matches said first password, the mobile communication device working normally if said second password matches said first password, and restricting functions of the mobile communication device if said second password doesn't match said first password; and
working normally if the system time does not equal the set time.

2. The method of claim 1, wherein said password verifying schedule is a period of time which starts upon storing the said password verifying schedule and said first password or upon verification that said second password matches said first password.

3. The method of claim 1, wherein the set time in said password verifying schedule is periodically occurring at an interval of a day, a week or a month.

4. The method of claim 1, wherein the functions of the mobile communication device are restricted after a number of times for which the user inputs said second password that doesn't match said first password exceeds a set number of times.

5. The method of claim 4, wherein the set number of times is three.

6. The method of claim 1, wherein restricting the functions of the mobile communication device includes allowing the user only to answer phone calls, allowing the user only to receive short messages, allowing the user only to dial emergency calls, disabling the operation of the mobile communication device, or causing the mobile communication device to enter into a shut down procedure.

7. The method of claim 4 further comprising the step of displaying a hint sentence set by the user at the same time as when said password verifying schedule and said first password are set to prompt the user to input said first password if the functions of the mobile communication device are restricted,.,

8. A mobile communication device with access protection, comprising:
an input device for inputting a password verifying schedule and a first password;
a storage device for storing said password verifying schedule and said first password;
a system clock for providing system time of the mobile communication device;
a display device for displaying information; and
a central processing unit for periodically determining whether the system time equals set time in the password verifying schedule;
wherein the central processing unit requires a user to input a second password by displaying information on the display device if the system time equals the set time, then verifies whether said second password matches said first password; then the mobile communication device works normally if said second password matches said first password, or otherwise the central processing unit restricts the functions of the mobile communication device if said second password doesn't match said first password; otherwise the mobile communication apparatus works normally if the system time does not equal the set time.

9. The mobile communication device of claim 8, wherein said password verifying schedule is a period of time which starts at a point of time upon storing said password verifying schedule and said first password or upon verification that said second password matches said first password, and the central processing unit stores a the point of time in the storage device.

10. The mobile communication device of claim 8, wherein said password verifying schedule is periodically occurring at an interval of a day, a week or a month.

11. The mobile communication device of claim 8, wherein the functions of the mobile communication device are restricted after a number of times, counted by the central processing unit, for which the user inputs said second password that doesn't match said first password exceeds a set number of times.

12. The mobile communication device of claim 11, wherein the set number of times is three.

13. The mobile communication device of claim 8, wherein restricting the functions of the mobile communication device includes allowing the user only to answer phone calls, allowing the user only to receive short messages, allowing the user only to dial emergency calls, disabling the operation of the mobile communication device, or causing the mobile communication device to enter into a shut down procedure.

14. The mobile communication device of claim 11, wherein when the functions of the mobile communication device are restricted, a hint sentence stored in the storage device is displayed by the display device to prompt the user to input said first password.
